(19) United States
(12) Patent Application Publication
(10) Pub. No.: US 2024/0345935 A1
(43) Pub. Date: Oct. 17, 2024

(54) PROCEDURE FOR PRE-DEPLOYMENT VALIDATION OF AI/ML ENABLED FEATURE

(71) Applicant: Nokia Technologies Oy, Espoo (FI)

(72) Inventors: Bharath Ramesh KASHYAP, Bangalore (IN); Vinayak BELLUR, Bangalore (IN); Dimitri GOLD, Espoo (FI); István Zsolt KOVÁCS, Aalborg (DK); Fahad SYED MUHAMMAD, Massy (FR); Sakira HASSAN, Espoo (FI)

(21) Appl. No.: 18/586,875

(22) Filed: Feb. 26, 2024

(30) Foreign Application Priority Data
Apr. 13, 2023 (IN) 202341027413

(51) Int. Cl. G06F 11/34; G06F 11/22; G06F 11/27

(52) U.S. Cl. CPC G06F 11/3447; G06F 11/2273; G06F 11/27

(57) ABSTRACT

An apparatus configured to: enter a test mode; receive, from a test equipment, an indication of at least one first model used at a first side of a two-sided model; request, from a model repository, at least one second model for use at a second side of the two-sided model, wherein the at least one second model is selected based, at least partially, on the at least one first model; and receive, from the model repository, the at least one second model. An apparatus configured to: receive, from a test equipment, a model validation request; provide a data set to at least one model to obtain an inference validation response, wherein the at least one model is used at a first side of a two-sided model; transmit, to the test equipment, the inference validation response; and receive, from the test equipment, a validation sequence result.

### RELATED APPLICATION

This application claims the benefit of, and priority from, India provisional Application No.: 202341027413 filed on Apr. 13, 2023, which is hereby incorporated by reference in its entirety.

### TECHNICAL FIELD

The example and non-limiting embodiments relate generally to the introduction of AI/ML-enabled features and AI/ML models and, more particularly, to interoperability and testability aspects of devices and the network.

### BACKGROUND

It is known, for an AI/ML-enabled feature, to implement a two-sided model at a UE and network, performance and validation may be ensured at both sides. As an example, in two-sided spatial domain channel state information (CSI) compression, the encoder/UE part of the model is at one node, and the decoder/NW part of the model is at another node; performance and validation may be ensured at each side.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: enter a test mode; receive, from a test equipment, an indication of at least one first model used at a first side of a two-sided model; request, from a model repository, at least one second model for use at a second side of the two-sided model, wherein the at least one second model is selected based, at least partially, on the at least one first model; and receive, from the model repository, the at least one second model.

In accordance with one aspect, a method comprising: entering a test mode at a device under test; receiving, from a test equipment, an indication of at least one first model used at a first side of a two-sided model; requesting, from a model repository, at least one second model for use at a second side of the two-sided model, wherein the at least one second model is selected based, at least partially, on the at least one first model; and receiving, from the model repository, the at least one second model.

In accordance with one aspect, an apparatus comprising means for performing: entering a test mode; receiving, from a test equipment, an indication of at least one first model used at a first side of a two-sided model; requesting, from a model repository, at least one second model for use at a second side of the two-sided model, wherein the at least one second model is selected based, at least partially, on the at least one first model; and receiving, from the model repository, the at least one second model.

In accordance with one aspect, a non-transitory computer-readable medium comprising program instructions stored thereon for performing at least the following: causing entering a test mode; causing receiving, from a test equipment, of an indication of at least one first model used at a first side of a two-sided model; causing requesting, from a model repository, of at least one second model for use at a second side of the two-sided model, wherein the at least one second model is selected based, at least partially, on the at least one first model; and causing receiving, from the model repository, of the at least one second model.

In accordance with one aspect, an apparatus comprising: at least one processor; and at least one memory storing instructions that, when executed by the at least one processor, cause the apparatus at least to: receive, from a test equipment, a model validation request; provide a data set to at least one model to obtain an inference validation response, wherein the at least one model is used at a first side of a two-sided model; transmit, to the test equipment, the inference validation response; and receive, from the test equipment, a validation sequence result.

In accordance with one aspect, a method comprising: receiving, with a device under test from a test equipment, a model validation request; providing a data set to at least one model to obtain an inference validation response, wherein the at least one model is used at a first side of a two-sided model; transmitting, to the test equipment, the inference validation response; and receiving, from the test equipment, a validation sequence result.

In accordance with one aspect, an apparatus comprising means for performing: receiving, from a test equipment, a model validation request; providing a data set to at least one model to obtain an inference validation response, wherein the at least one model is used at a first side of a two-sided model; transmitting, to the test equipment, the inference validation response; and receiving, from the test equipment, a validation sequence result.

In accordance with one aspect, a non-transitory computer-readable medium comprising program instructions stored thereon for performing at least the following: causing receiving, from a test equipment, of a model validation request; causing providing of a data set to at least one model to obtain an inference validation response, wherein the at least one model is used at a first side of a two-sided model; causing transmitting, to the test equipment, of the inference validation response; and causing receiving, from the test equipment, of a validation sequence result.

In accordance with one aspect, an apparatus comprising: at least one processor; and at least one memory storing instructions that, when executed by the at least one processor, cause the apparatus at least to: enter a test mode; request, from a model repository, at least one first model for use at a first side of a two-sided model; receive, from the model repository, the at least one first model; and transmit, to a device under test, an indication of the at least one first model.

In accordance with one aspect, a method comprising: entering a test mode; requesting, with a test equipment from a model repository, at least one first model for use at a first side of a two-sided model; receiving, from the model repository, the at least one first model; and transmitting, to a device under test, an indication of the at least one first model.

In accordance with one aspect, an apparatus comprising means for performing: entering a test mode; requesting, from a model repository, at least one first model for use at a first side of a two-sided model; receiving, from the model repository, the at least one first model; and transmitting, to a device under test, an indication of the at least one first model.

In accordance with one aspect, a non-transitory computer-readable medium comprising program instructions stored thereon for performing at least the following: causing entering a test mode; causing requesting, from a model repository, of at least one first model for use at a first side of a two-sided model; causing receiving, from the model repository, of the at least one first model; and causing transmitting, to a device under test, of an indication of the at least one first model.

In accordance with one aspect, an apparatus comprising: at least one processor; and at least one memory storing instructions that, when executed by the at least one processor, cause the apparatus at least to: transmit, to a device under test, a model validation request; receive, from the device under test in response to the model validation request, an inference validation response; provide the inference validation response to at least one first model to obtain a corresponding inference, wherein the at least one first model is used at the device under test, wherein the at least one first model is part of a two-sided model; determine a validation sequence result based, at least partially, on the corresponding inference and at least one key performance indicator; and transmit, to the device under test, the validation sequence result.

In accordance with one aspect, a method comprising: transmitting, with a test equipment to a device under test, a model validation request; receiving, from the device under test in response to the model validation request, an inference validation response; providing the inference validation response to at least one first model to obtain a corresponding inference, wherein the at least one first model is used at the device under test, wherein the at least one first model is part of a two-sided model; determining a validation sequence result based, at least partially, on the corresponding inference and at least one key performance indicator; and transmitting, to the device under test, the validation sequence result.

In accordance with one aspect, an apparatus comprising means for performing: transmitting, to a device under test, a model validation request; receiving, from the device under test in response to the model validation request, an inference validation response; providing the inference validation response to at least one first model to obtain a corresponding inference, wherein the at least one first model is used at the device under test, wherein the at least one first model is part of a two-sided model; determining a validation sequence result based, at least partially, on the corresponding inference and at least one key performance indicator; and transmitting, to the device under test, the validation sequence result.

In accordance with one aspect, a non-transitory computer-readable medium comprising program instructions stored thereon for performing at least the following: causing transmitting, to a device under test, of a model validation request; causing receiving, from the device under test in response to the model validation request, of an inference validation response; causing providing of the inference validation response to at least one first model to obtain a corresponding inference, wherein the at least one first model is used at the device under test, wherein the at least one first model is part of a two-sided model; determining a validation sequence result based, at least partially, on the corresponding inference and at least one key performance indicator; and causing transmitting, to the device under test, of the validation sequence result.

In accordance with one aspect, an apparatus comprising: at least one processor; and at least one memory storing instructions that, when executed by the at least one processor, cause the apparatus at least to: receive a request for at least one model for use at a first side of a two-sided model; provide the at least one model in response to the request; and receive at least one validation sequence result with respect to the two-sided model, wherein the at least one validation sequence result is associated with an identifier of the two-sided model.

In accordance with one aspect, a method comprising: receiving, with a repository, a request for at least one model for use at a first side of a two-sided model; providing the at least one model in response to the request; and receiving at least one validation sequence result with respect to the two-sided model, wherein the at least one validation sequence result is associated with an identifier of the two-sided model.

In accordance with one aspect, an apparatus comprising means for performing: receiving a request for at least one model for use at a first side of a two-sided model; providing the at least one model in response to the request; and receiving at least one validation sequence result with respect to the two-sided model, wherein the at least one validation sequence result is associated with an identifier of the two-sided model.

In accordance with one aspect, a non-transitory computer-readable medium comprising program instructions stored thereon for performing at least the following: causing receiving of a request for at least one model for use at a first side of a two-sided model; causing providing of the at least one model in response to the request; and causing receiving of at least one validation sequence result with respect to the two-sided model, wherein the at least one validation sequence result is associated with an identifier of the two-sided model.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4A and FIG. 4B provide a diagram illustrating features as described herein;

FIG. 5 is a flowchart illustrating steps as described herein;

FIG. 6 is a flowchart illustrating steps as described herein;

FIG. 7 is a flowchart illustrating steps as described herein;

FIG. 8 is a flowchart illustrating steps as described herein; and

FIG. 9 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
AI artificial intelligence
AMF access and mobility management function
BER bit error rate
BLER block error rate
cRAN cloud radio access network
CU central unit
DU distributed unit
DUT device under test
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
KPI key performance indicator
L1 layer 1
LCM life cycle management
LTE long term evolution
MAC medium access control
ML machine learning
MME mobility management entity
ng or NG new generation
ng-eNB or NG-eNB new generation eNB
NR new radio
N/W or NW network
O-RAN open radio access network
PDCP packet data convergence protocol
PHY physical layer
RAN radio access network
RF radio frequency
RLC radio link control
RRC radio resource control
RRH remote radio head
RS reference signal
RU radio unit
Rx receiver
SDAP service data adaptation protocol
SGW serving gateway
SMF session management function
TE test equipment
Tx transmitter
UE user equipment (e.g., a wireless, typically mobile device)
UPF user plane function
VNR virtualized network function

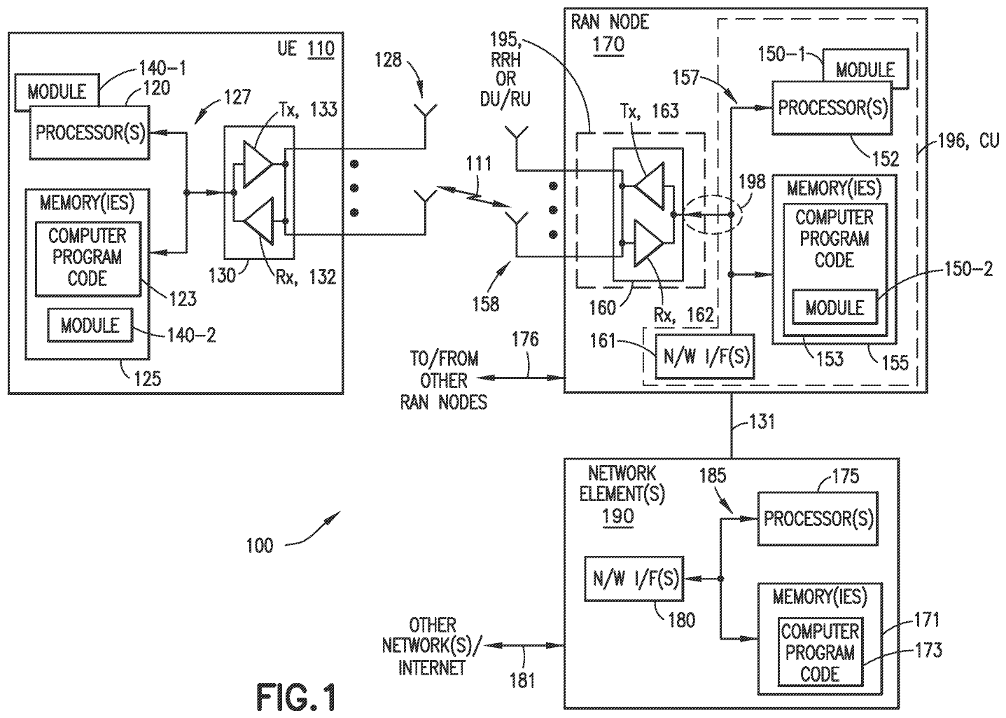

Turning to FIG. 1, this figure shows a block diagram of one possible and non-limiting example in which the examples may be practiced. A user equipment (UE) 110, radio access network (PAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with PAN node 170 via a wireless link 111.

The RAN node 170 in this example is a base station that provides access by wireless devices such as the UE 110 to the wireless network 100. The PAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the PAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The PAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the PAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the PAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function (s) (AMFF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The PAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to artificial intelligence (AI) and/or machine learning (ML). A study of AI/ML for New Radio (NR) air interface is now ongoing in 3GPP Rel-18. One of the objectives of the study is to cover the interoperability and testability aspect of the newly defined AI/ML enabled features.

In the present description, an ML model may comprise one or more functionalities. A functionality may comprise one or more functions and/or features. An example of a function/feature is CSI reporting. One or more functionalities may provide the function/feature of CSI reporting. For example, CSI reporting may be provided with regular (non-ML) CSI Type II reporting, or with ML-based functionalities, such as CSI compression or CSI prediction. AI/ML enabled functionalities may be implemented with one or several ML models.

AI/ML-enabled functionalities and ML models may impact the testability of UE devices.

Features as described in the present disclosure may generally relate to interoperability and testability aspects of device and network under test, with respect to AI/ML enabled features and AI/ML models at the device and network.

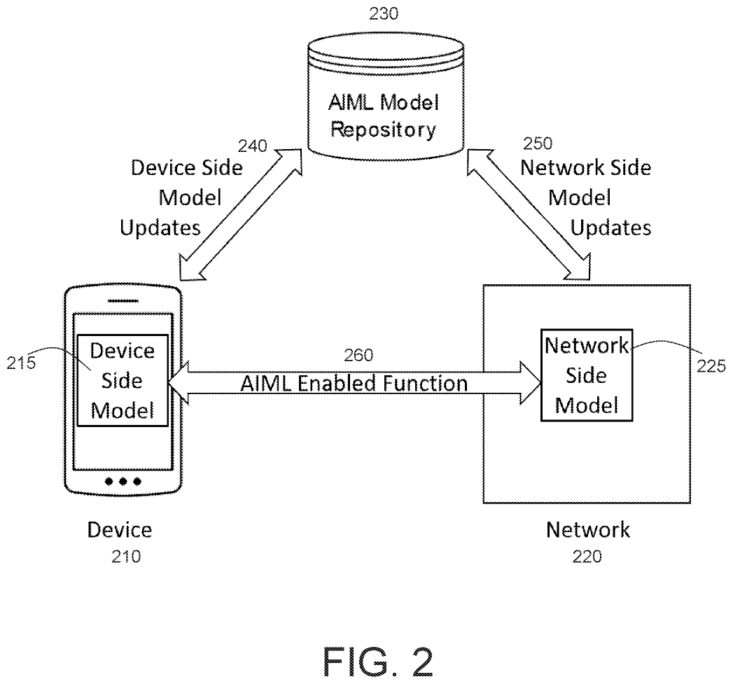

The issue becomes even more complicated when an ML-enabled feature introduces coordinated use of AI/ML models both at the device (e.g. user equipment (UE)) and the network (NW). Such models are known as the two-sided models, and one example is shown in FIG. 2.

Referring now to FIG. 2, illustrated is an example of an AI/ML enabled features with a two-sided model. In this example, a single AI/ML model repository (230) (e.g. centralized repository) is used for both the device (215) and the network side model (225). However, separate AI/ML model repositories may be used for the device side and for the network side. Device side model updates (240) may be interchanged between the device side model (215) and the AI/ML model repository (230). Network side model updates (250) may be interchanged between the network side model (225) and the AI/ML model repository (230).

In FIG. 2, there are two different AI/ML models deployed (215, 225), both at the device (210) and the network (220), to realize the AI/ML enabled function (260). Both these models should be interoperable and work in tandem with each other to realize the utility of the AI/ML function.

It may be necessary to test, at the network, an AI/ML functionality which uses two-sided ML models (e.g. at UE and gNB). Pre-deployment interoperability & testability procedures may address one or more of the following: (1) The sources of models (servers training the two models, input data used for the training and validation) for both the device and network may be different; (2) The versions of the models available at the device and/or the network may become different; (3) The update cycle of the models for both the device and the network may be different; (4) There may be no mechanism available to co-ordinate the interoperability of the models so that the end to end flow may be validated before it may be used for testing; (5) The life cycle management (LCM) frameworks proposed so far in 3GPP RAN1-2 do not address specifics of 2-sided models (see prior-art section) although it is likely that both sides (UE and gNB) would request tracking of versions on the other side; (6) It is not clear how to align both models after each new update.

Following the list of issues above, it may be hard to ensure that interoperability between the models is achieved during/before the testing. An exclusive AI/ML model LCM may be required specifically for validating the interoperability of models for AI/ML enabled features.

In an example embodiment, a two-sided ML model testing specific procedure (signaling and behavior) may be part of the AIML model life cycle management. A technical effect of example embodiments of the present disclosure may be to achieve consistent interoperability and testability of AI/ML-enabled features, ML functionalities, and/or ML models.

In order to perform conformance testing of an ML functionality based on two-sided ML model(s), as a first step, it may be determined whether the ML model parts at both the device and the network side are interoperable before the ML models are actually deployed and the actual ML-enabled feature/functionality is tested.

A technical effect of example embodiments of the present disclosure may be to achieve interoperability.

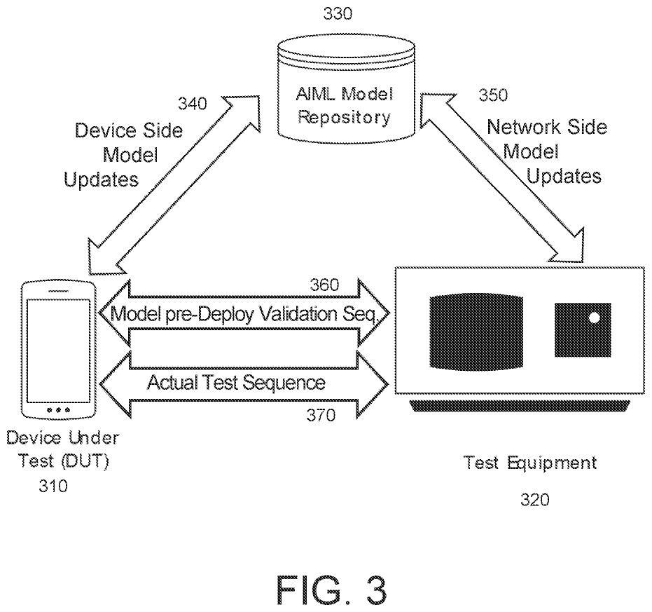

In an example embodiment, a pre-deployment validation sequence (e.g. as illustrated in FIG. 3, marked as (360)) may be introduced. The pre-deployment validation sequence may be carried out by the test equipment (TE) with the device under test (DUT). In an example embodiment, the DUT may be a user equipment. In another example embodiment, the DUT may be a gNB or other network entity.

Referring now to FIG. 3, illustrated is an example of an ML model pre-deployment validation sequence. For simplicity, depicted is the case where a single AI/ML model repository (330) is used for the device (310) and network (320) side models. Example embodiments may also be applicable where separate AI/ML model repositories are used. The DUT (310) may interchange device side model updates (340) with the AI/ML model repository (330). The TE (320) may interchange network side model updates (350).

Once the interoperability is validated (360), the TE (320) may continue further testing of the actual performance of the functionality and/or ML model using the actual test sequence (as illustrated in FIG. 3, marked as (370)).

In an example embodiment, a framework for pre-deployment validation of AI/ML enabled functions may be implemented.

In an example embodiment, a new dedicated Test mode for AI enabled feature validation may be added. This may involve exchanges of new messages between the DUT and the device ML model repository.

In an example embodiment, a model validation mechanism may be implemented. This may involve exchanges of new messages between the DUT and the TE.

In an example embodiment, a pre-deployment validation sequence may be introduced to validate the interoperability and testability of the ML-enabled features and functionalities based on 2-sided ML models solutions.

In an example embodiment, the ML model repository (or joint repository) may be updated based on the outcome(s) of DUT validation.

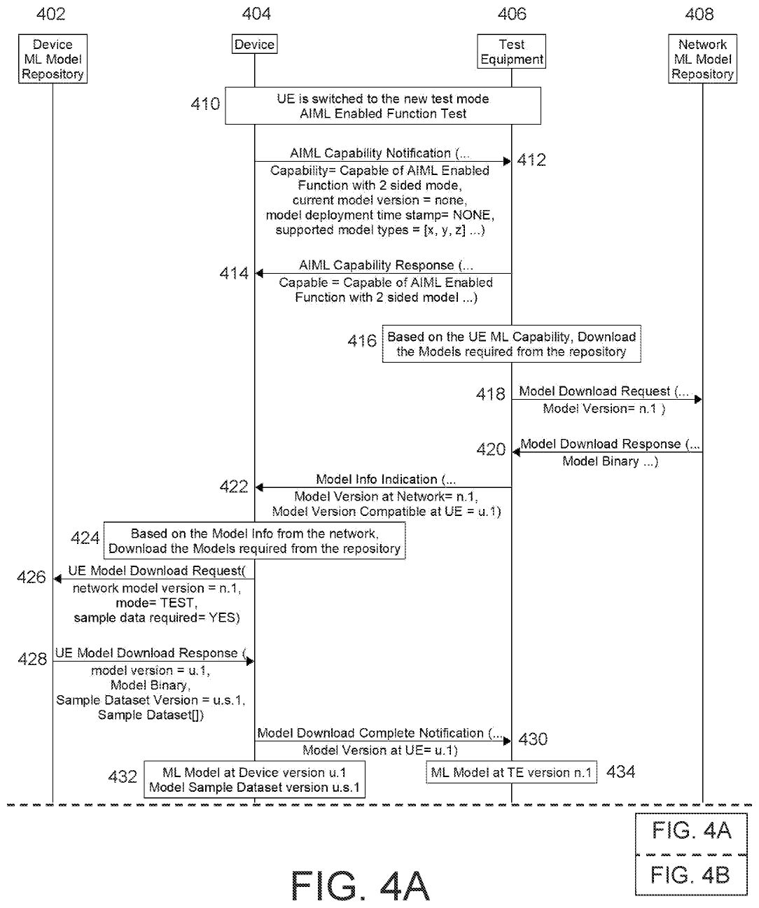

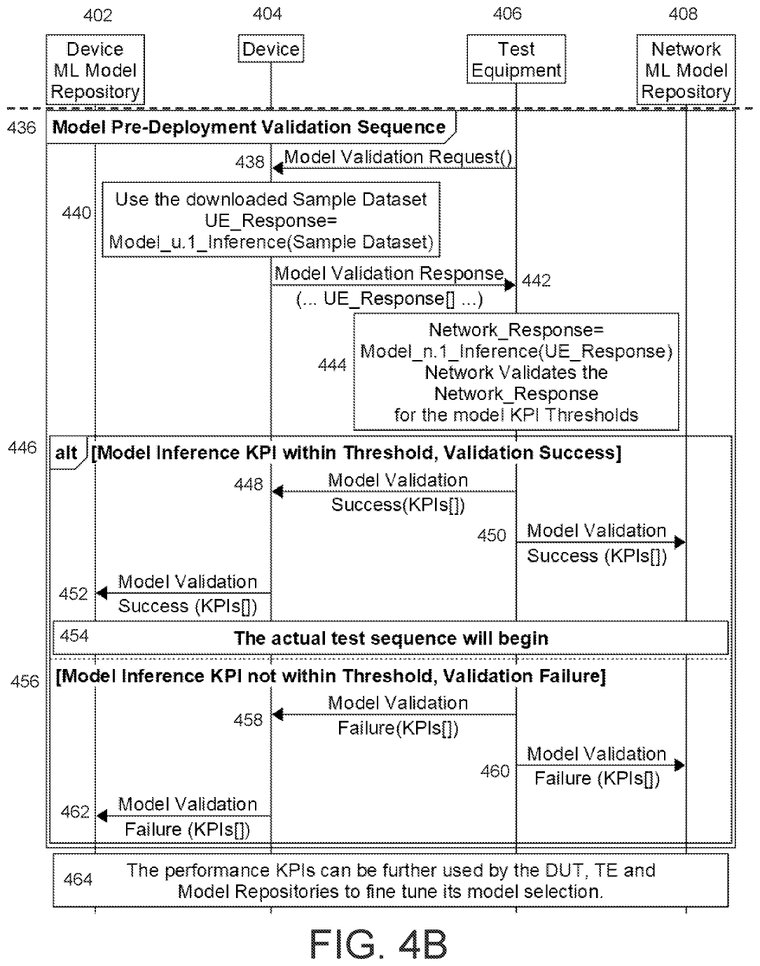

Referring now to FIG. 4A and FIG. 4B, illustrated is a message flow for a pre-deployment validation sequence according to an example embodiment of the present disclosure.

In an example embodiment, the DUT (404) and, optionally, the TE (406) may be switched to a new test mode, the AI/ML enabled feature test mode. At 412, the DUT (440) may send its AI/ML capability to the TE (406), and may notify the TE (406) of its capability to support the AI/ML enabled feature with a two-sided model. The DUT (404) may also share the model ID(s)/functionality IDs on the device, along with the other auxiliary (meta) information (e.g. functionality/model versions). For example, the DUT (404) may indicate its current model version (e.g. none). For example, the DUT (404) may indicate its model deployment time stamp (e.g. none). For example, the DUT (404) may indicate its supported model types (e.g. [x, y, z]). Alternatively, supported model ID(s)/functionality ID(s) may be shared if the models are not available on the DUT.

At 414, the TE (406) may respond with its capability to support AI/ML-enabled feature with two-sided model. At 416, based on the AI/ML capability of the DUT, the TE (406) may determine to download the required network side models from the TE ML model repository (408). In an example, the TE ML model repository (408) may be local, for example available in the TE, or in a separate equipment connected directly to the TE. In an example, the TE ML model repository (408) may be remote, for example accessed via Internet connection to a pre-configured network vendor/TE vendor server(s)/public repositories/etc. At 418, the TE (406) may transmit, to the network ML model repository (408), a model download request. The model download request may include an indication of the model version to be downloaded. At 420, the network ML model repository (408) may transmit, to the TE (406), a model download response. The model download response may include a model binary, model related information, model threshold related information that helps in validating the functionality of the model, etc. In the example of FIG. 4A and FIG. 4B, a network side ML model n.1 may be downloaded at the TE (406). In an example embodiment, the TE (406) may have an additional capability to locally train/update the model received from the network ML model repository (408) based on the input/information provided by the UE (404) (i.e. if UE-model first training approach is used). The UE (404) may perform model training based on the same information.

At 422, the TE (406) may inform the DUT (404) about the network side ML model update, for example by indicating the ML model ID, for example n.1. Additionally, the TE (406) may inform the DUT (404) of the model version compatible at the UE, for example u.1.

At 424, the DUT (404) may determine to download model(s) from the device ML model repository (402). At 426, based on the ML model ID (e.g. list of ML model IDs or functionality ID(s)) indicated by the TE (406), the DUT (404) may request suitable ML model(s) from its own device ML model repository (402). The DUT (404) may inform the device ML model repository (402) about the test mode enabled at 410, and may also request corresponding reference training/validation data set(s).

If the DUT (404) is capable of training its own model, it may use simulation data provided by the TE (406). However, if the DUT (404) is not capable of training the model on its own, then it may get the training/validation data from the device repository (402) or from the TE (406), if the TE has the information about the device side model that is being used and has access to the corresponding training/validation data (e.g. joint repository).

In an example, the device ML model repository may be local, for example in a separate DUT vendor specific equipment connected directly to the DUT (404). In an example, the device ML model repository may be remote, for example accessed via Internet connection to pre-configured UE vendor specific server(s) or a public repository. In an example embodiment, the UE model download request may comprise a network model version (e.g. n.1), an indication of a mode (e.g. TEST), and an indication that sample data is required (e.g. YES). At 428, the requested ML model, along with the sample data, may be downloaded from the device ML model repository (402) into the DUT (404). In an example embodiment, the device ML model repository (402) may transmit, to the DUT (404), a UE model download response. The UE model download response may comprise an indication of a model version (e.g. u.1, model binary), an indication of a sample dataset version (e.g. u.s.1), and a sample dataset.

At 430, the DUT (404) may inform the TE (406) about the ML model availability. For example, the DUT (404) may transmit a model download complete notification, which may include an indication of the model version at the UE (e.g. u.1). At this point, at 432, the DUT (404) may have a ML model with version u.1, and corresponding reference training/validation data set(s) version u.s.1. At this point, at 434, the TE (406) may have the ML model with version n.1.

At 436, the model pre-deployment validation sequence may be performed. At 438, the TE (406) may trigger a model validation request to the DUT (404). At 440, the DUT (404) may use the reference dataset u.s.1 as an input to the model u.1 to derive the inference validation response. At 442, the UE_Response may be sent to the TE (406). At 444, the inference validation response may be used as an input to the TE-side ML model n.1, and the corresponding inference may be derived. The inference output may then be used to estimate the full ML model and functionality performance (proxy/intermediary key performance indicators (KPIs) and/or system KPIs) at the TE (406). For example, the TE (406) may validate the network response based, at least partially, on the model KPI threshold(s).

System KPIs may be functionality specific KPIs, such as throughput, latency, block error rate (BLER), bit error rate (BER), number of Re-TX, etc. These KPIs may be considered to evaluate the performance as of today, without ML (or without knowing that ML is used in the UE).

Proxy/intermediary KPIs may be AI/ML specific KPIs, such as the scaled generalized cosine similarity metric used in the CSI compression (and prediction), and the top-K beam prediction accuracy used in the beamforming matrix (BM) prediction use case. These KPIs may better reflect the performance of the ML model used, and without the need to know the exact structure of the model (inputs, output, labels).

Based on the performance KPI(s), the TE (406) may send the validation sequence result, which may indicate validation success (446) or validation failure (456).

At 446, if the model inference KPI is within the threshold, then at 448, an indication of validation success, along with the result of the comparison of the output of the performance KPIs (i.e. application of performance KPI to received model validation response) with one or more threshold values, may be sent back to the device (404). At 450 and 452, the indication of validation success and performance KPI comparison result(s) may also be shared to the model repositories (402, 408). At 454, the actual test sequence may begin in response to the validation success.

At 456, if the model inference KPI is not within the threshold (e.g. above a maximum threshold value, or below a minimum threshold value), then an indication of validation failure, along with the performance KPI comparison result(s), may be sent back to the device (404). At 460 and 462, the indication of validation failure and the performance KPI comparison result(s) may also be shared to the model repositories (402, 408).

In an example embodiment, the model inference KPIs may be used for both the UE_Response and the Network_Response. The model inference KPIs and thresholds used for each of the UE_Response and the Network_Response may not be the same.

At 464, the validation sequence result received from the TE (406) may be used by the DUT (404) to perform at least one of the following.

For example, the ML model u.1 (at the DUT (404)) may be enabled for follow-up performance testing procedure(s).

For example, the DUT (404) may select a new ML model. A new ML model may be selected in case of model validation failure, if there are multiple model versions based on different training sets to be tested, or if the model has passed validation criteria but is not satisfying an internal KPI of the DUT (e.g. received performance KPI comparison result does not meet a threshold value, at the DUT, for the KPI). If a new ML model is selected, the DUT (404) may proceed from 426, transmission of a UE model download request to the device ML model repository (402).

For example, the DUT (404) may adjust its capability. For example, the capability may be adjusted if more/less neural engine cores are required to do inference for a model; in such a case, that allocation may be performed. If the capability is adjusted, the DUT (404) may proceed from 412, transmission of an AI/ML capability notification to the TE (406).

For example, the DUT (404) may indicate, to the model repository (402), incompatibility with the requirements. For example, the DUT (404) may stop the pre-deployment validation sequence. Incompatibility with the requirements may be indicated in case of model validation failure, or when the model is not performing as per the expected KPI (i.e. the threshold associated with a given KPI), even though it has passed the validation criteria. In response, the model repository (402) may take some action with respect to the version of the model under test.

In an example embodiment, the validation sequence result may be used by the device and/or model repositories to improve the training set, and/or optimize the models.

While in the example of FIG. 4A and FIG. 4B the DUT is a device or user equipment, this is not limiting; the DUT may be a gNB, network node, etc.

While in the example of FIG. 4A and FIG. 4B both a device ML model repository and a network ML model repository are considered, this is not limiting; a single ML model repository may be used by both the DUT side and the TE side (i.e. same repository used throughout the pre-deployment validation sequence).

In an example embodiment, the TE may be configured. For example, the TE may be configured to store/contain the log files. For example, the TE may be configured to test a set of sanity check of LCM operations of the models (activation, deactivation, fallback). For example, the TE may be configured to perform a sanity/consistency check of a switching operation, for example if multiple models are included for the same functionality. For example, the TE may be configured to perform a sanity/consistency check for configuration profile matching (e.g. model architecture, number of inputs/outputs, etc.). For example, the TE may be configured to perform a validity check for different configuration scenarios. For example, the TE may be configured with validation performance KPIs (if any) of both the UE and network side models.

A technical effect of example embodiments of the present disclosure may be to enable the device side of the two-sided models to be validated with sample data used for training the device side model.

A technical effect of example embodiments of the present disclosure may be enabling use with independent vendors for both device and network models.

A technical effect of example embodiments of the present disclosure may be to provide a framework for such testing and exchanges of messages between TE and DUT.

A technical effect of example embodiments of the present disclosure may be to enable multiple models from across vendors to be selected and validated for compatibility.

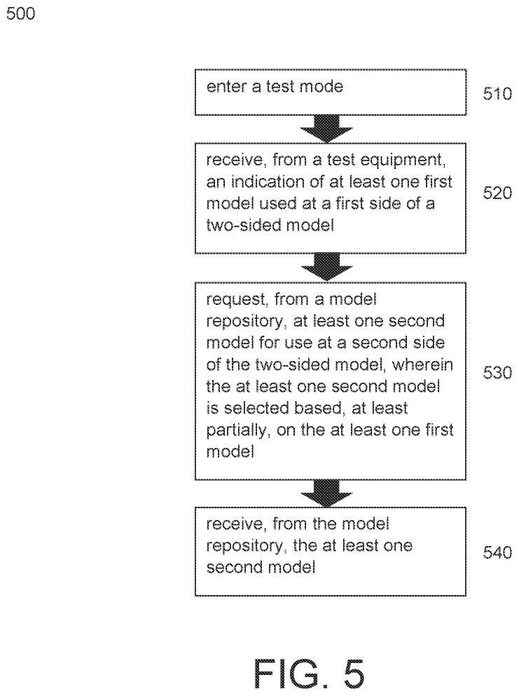

FIG. 5 illustrates the potential steps of an example method 500. The example method 500 may include: entering a test mode, 510; receiving, from a test equipment, an indication of at least one first model used at a first side of a two-sided model, 520; requesting, from a model repository, at least one second model for use at a second side of the two-sided model, wherein the at least one second model is selected based, at least partially, on the at least one first model, 530; and receiving, from the model repository, the at least one second model, 540. The example method 500 may be performed, for example, with a DUT, a UE, a network node, etc.

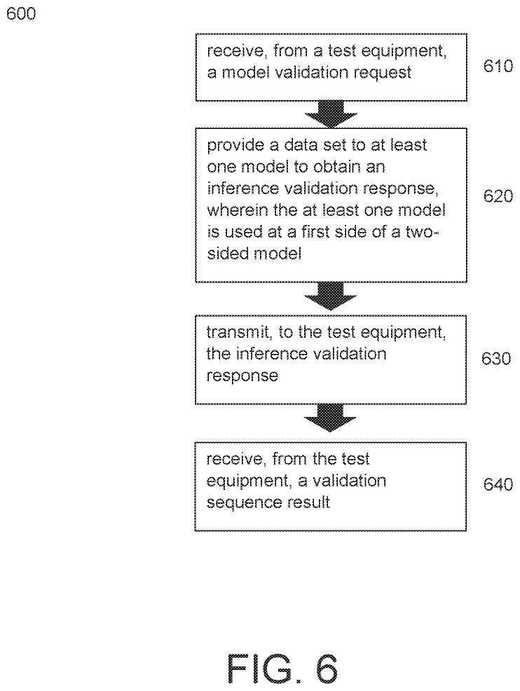

FIG. 6 illustrates the potential steps of an example method 600. The example method 600 may include: receiving, from a test equipment, a model validation request, 610; providing a data set to at least one model to obtain an inference validation response, wherein the at least one model is used at a first side of a two-sided model, 620; transmitting, to the test equipment, the inference validation response, 630; and receiving, from the test equipment, a validation sequence result, 640. The example method 600 may be performed, for example, with a DUT, a UE, a network node, etc.

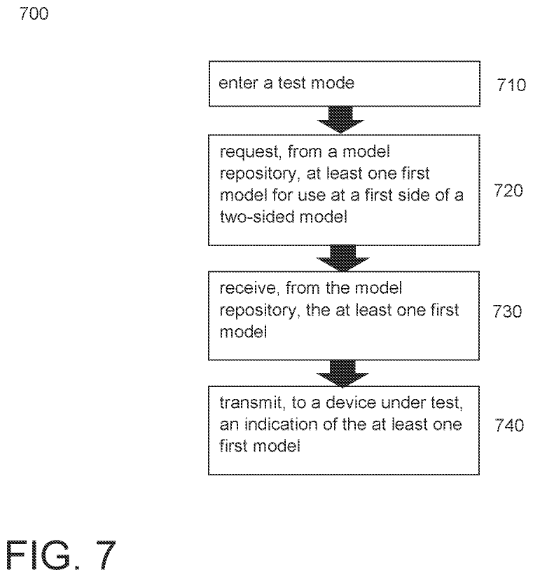

FIG. 7 illustrates the potential steps of an example method 700. The example method 700 may include: entering a test mode, 710; requesting, from a model repository, at least one first model for use at a first side of a two-sided model, 720; receiving, from the model repository, the at least one first model, 730; and transmitting, to a device under test, an indication of the at least one first model, 740. The example method 700 may be performed, for example, with a test equipment, network node, base station, gNB, network, etc.

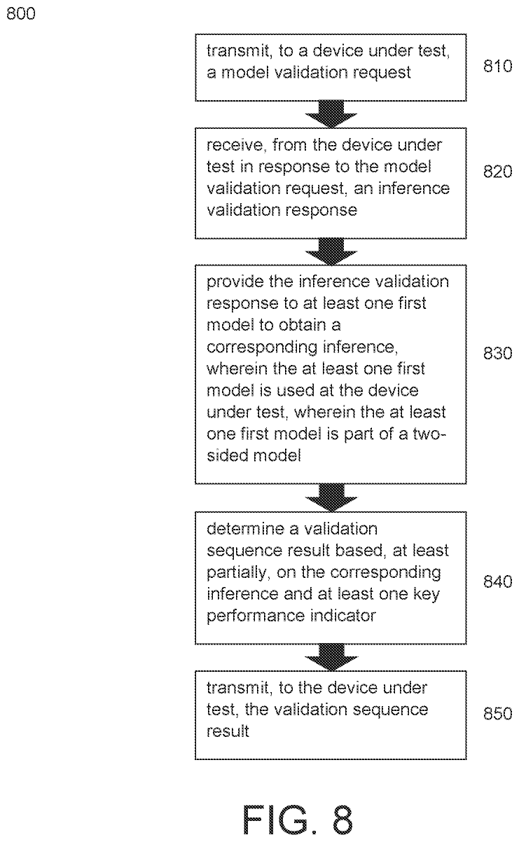

FIG. 8 illustrates the potential steps of an example method 800. The example method 800 may include: transmitting, to a device under test, a model validation request, 810; receiving, from the device under test in response to the model validation request, an inference validation response, 820; providing the inference validation response to the at least one first model to obtain a corresponding inference, wherein the at least one first model is used at the device under test, wherein the at least one first model is part of a two-sided model, 830; determining a validation sequence result based, at least partially, on the corresponding inference and at least one key performance indicator, 840; and transmitting, to the device under test, the validation sequence result, 850. The example method 800 may be performed, for example, with a test equipment, network node, base station, gNB, network, etc.

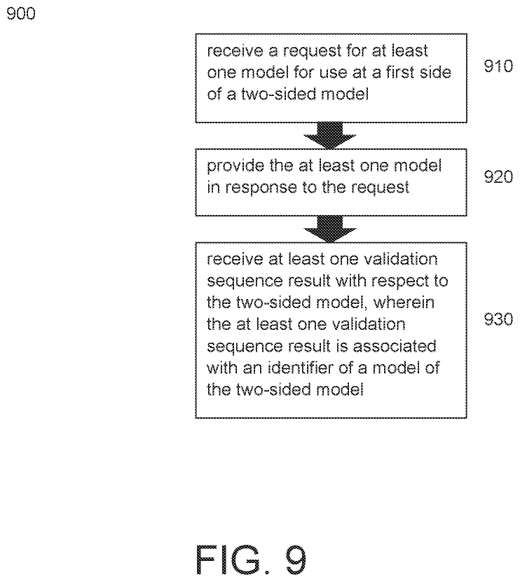

FIG. 9 illustrates the potential steps of an example method 900. The example method 900 may include: receiving a request for at least one model for use at a first side of a two-sided model, 910; providing the at least one model in response to the request, 920; and receiving at least one validation sequence result with respect to the two-sided model, wherein the at least one validation sequence result is associated with an identifier of the two-sided model, 930. The example method 900 may be performed, for example, with a ML model repository, a device model repository, a network model repository, a centralized model repository, a local repository, a remote repository, a network node acting as a repository, a UE acting as a repository, etc.

In accordance with one example embodiment, an apparatus may comprise: at least one processor; and at least one memory storing instructions that, when executed by the at least one processor, cause the apparatus at least to: enter a test mode; receive, from a test equipment, an indication of at least one first model used at a first side of a two-sided model; request, from a model repository, at least one second model for use at a second side of the two-sided model, wherein the at least one second model may be selected based, at least partially, on the at least one first model; and receive, from the model repository, the at least one second model.

The example apparatus may be further configured to: transmit, to the test equipment, a first indication of a capability to support at least one feature with the two-sided model; and receive, from the test equipment, a second indication that the test equipment is capable of supporting the at least one feature with the two-sided model.

The first indication may comprise at least one of: a first identifier of a model available to the apparatus, a first version of the model, a second identifier of a functionality available to the apparatus, or a second version of the functionality.

The indication of the at least one first model may comprise at least one of: an update to the at least one first model, or a third identifier of the at least one first model.

The example apparatus may be further configured to: transmit, to the model repository, a third indication of the test mode of the apparatus.

The model repository may comprise one of: a device model repository, a network model repository, a centralized model repository, a local repository, or a remote repository.

The example apparatus may be further configured to: transmit, to the test equipment, a fourth indication that the at least one second model has been obtained.

The example apparatus may comprise a user equipment.

The example apparatus may comprise a network node.

In accordance with one aspect, an example method may be provided comprising: entering a test mode at a device under test; receiving, from a test equipment, an indication of at least one first model used at a first side of a two-sided model; requesting, from a model repository, at least one second model for use at a second side of the two-sided model, wherein the at least one second model may be selected based, at least partially, on the at least one first model; and receiving, from the model repository, the at least one second model.

The example method may further comprise: transmitting, to the test equipment, a first indication of a capability to support at least one feature with the two-sided model; and receiving, from the test equipment, a second indication that the test equipment is capable of supporting the at least one feature with the two-sided model.

The first indication may comprise at least one of: a first identifier of a model available to the device under test, a first version of the model, a second identifier of a functionality available to the device under test, or a second version of the functionality.

The indication of the at least one first model may comprise at least one of: an update to the at least one first model, or a third identifier of the at least one first model.

The example method may further comprise: transmitting, to the model repository, a third indication of the test mode of the apparatus.

The model repository may comprise one of: a device model repository, a network model repository, a centralized model repository, a local repository, or a remote repository.

The example method may further comprise: transmitting, to the test equipment, a fourth indication that the at least one second model has been obtained.

The device under test may comprise a user equipment.

The device under test may comprise a network node.

In accordance with one example embodiment, an apparatus may comprise: circuitry configured to perform: entering a test mode; circuitry configured to perform: receiving, from a test equipment, an indication of at least one first model used at a first side of a two-sided model; circuitry configured to perform: requesting, from a model repository, at least one second model for use at a second side of the two-sided model, wherein the at least one second model may be selected based, at least partially, on the at least one first model; and circuitry configured to perform: receiving, from the model repository, the at least one second model.

In accordance with one example embodiment, an apparatus may comprise: processing circuitry; memory circuitry including computer program code, the memory circuitry and the computer program code configured to, with the processing circuitry, enable the apparatus to: enter a test mode; receive, from a test equipment, an indication of at least one first model used at a first side of a two-sided model; request, from a model repository, at least one second model for use at a second side of the two-sided model, wherein the at least one second model may be selected based, at least partially, on the at least one first model; and receive, from the model repository, the at least one second model.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: entering a test mode; receiving, from a test equipment, an indication of at least one first model used at a first side of a two-sided model; requesting, from a model repository, at least one second model for use at a second side of the two-sided model, wherein the at least one second model may be selected based, at least partially, on the at least one first model; and receiving, from the model repository, the at least one second model.

The means may be further configured to perform: transmitting, to the test equipment, a first indication of a capability to support at least one feature with the two-sided model; and receiving, from the test equipment, a second indication that the test equipment is capable of supporting the at least one feature with the two-sided model.

The first indication may comprise at least one of: a first identifier of a model available to the apparatus, a first version of the model, a second identifier of a functionality available to the apparatus, or a second version of the functionality.

The indication of the at least one first model may comprise at least one of: an update to the at least one first model, or a third identifier of the at least one first model.

The means may be further configured to perform: transmitting, to the model repository, a third indication of the test mode of the apparatus.

The model repository may comprise one of: a device model repository, a network model repository, a centralized model repository, a local repository, or a remote repository.

The means may be further configured to perform: transmitting, to the test equipment, a fourth indication that the at least one second model has been obtained.

The example apparatus may comprise a user equipment.

The example apparatus may comprise a network node.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: enter a test mode; causing receiving, from a test equipment, of an indication of at least one first model used at a first side of a two-sided model; cause requesting, from a model repository, of at least one second model for use at a second side of the two-sided model, wherein the at least one second model may be selected based, at least partially, on the at least one first model; and cause receiving, from the model repository, of the at least one second model.

In accordance with one example embodiment, a non-transitory computer-readable medium comprising program instructions stored thereon for performing at least the following: entering a test mode; causing receiving, from a test equipment, of an indication of at least one first model used at a first side of a two-sided model; causing requesting, from a model repository, of at least one second model for use at a second side of the two-sided model, wherein the at least one second model may be selected based, at least partially, on the at least one first model; and causing receiving, from the model repository, of the at least one second model.

In accordance with another example embodiment, a non-transitory program storage device readable by a machine may be provided, tangibly embodying instructions executable by the machine for performing operations, the operations comprising: entering a test mode; causing receiving, from a test equipment, of an indication of at least one first model used at a first side of a two-sided model; causing requesting, from a model repository, of at least one second model for use at a second side of the two-sided model, wherein the at least one second model may be selected based, at least partially, on the at least one first model; and causing receiving, from the model repository, of the at least one second model.

In accordance with another example embodiment, a non-transitory computer-readable medium comprising instructions that, when executed by an apparatus, cause the apparatus to perform at least the following: entering a test mode; causing receiving, from a test equipment, of an indication of at least one first model used at a first side of a two-sided model; causing requesting, from a model repository, of at least one second model for use at a second side of the two-sided model, wherein the at least one second model may be selected based, at least partially, on the at least one first model; and causing receiving, from the model repository, of the at least one second model.

A computer implemented system comprising: at least one processor and at least one non-transitory memory storing instructions that, when executed by the at least one processor, cause the system at least to perform: entering a test mode; causing receiving, from a test equipment, of an indication of at least one first model used at a first side of a two-sided model; causing requesting, from a model repository, of at least one second model for use at a second side of the two-sided model, wherein the at least one second model may be selected based, at least partially, on the at least one first model; and causing receiving, from the model repository, of the at least one second model.

A computer implemented system comprising: means for entering a test mode; means for causing receiving, from a test equipment, of an indication of at least one first model used at a first side of a two-sided model; means for causing requesting, from a model repository, of at least one second model for use at a second side of the two-sided model, wherein the at least one second model may be selected based, at least partially, on the at least one first model; and means for causing receiving, from the model repository, of the at least one second model.

In accordance with one example embodiment, an apparatus may comprise: at least one processor; and at least one memory storing instructions that, when executed by the at least one processor, cause the apparatus at least to: receive, from a test equipment, a model validation request; provide a data set to at least one model to obtain an inference validation response, wherein the at least one model may be used at a first side of a two-sided model; transmit, to the test equipment, the inference validation response; and receive, from the test equipment, a validation sequence result.

The example apparatus may be further configured to: provide, to a model repository, the validation sequence result.

The example apparatus may be further configured to: transmit, to the model repository, a request for the data set; and receive, from the model repository, the data set.

The example apparatus may be further configured to: indicate, to the model repository, an incompatibility with a model of a machine learning enabled functionality using the two-sided model in response to the validation sequence result.

The validation sequence result may comprise a result of at least one key performance indicator used in a validation sequence with respect to the machine learning enabled functionality that may be using the two-sided model.

The at least one key performance indicator may comprise at least one of: a proxy key performance indicator, an intermediary key performance indicator, a system key performance indicator, a throughput, a latency, a bit error rate, a block error rate, a number of transmissions, a second number of receptions, a scaled generalized cosine similarity metric, or a top beam prediction accuracy.

The validation sequence result may comprise a model validation success result.

The validation sequence result may comprise a model validation failure result.

The example apparatus may be further configured to: perform at least one test procedure with respect to the at least one model in response to the validation sequence result.

The example apparatus may be further configured to: select a model that may be at least partially different from the at least one model in response to the validation sequence result.

The example apparatus may be further configured to: adjust a capability of the apparatus in response to the validation sequence result.

In accordance with one aspect, an example method may be provided comprising: receiving, with a device under test from a test equipment, a model validation request; providing a data set to at least one model to obtain an inference validation response, wherein the at least one model may be used at a first side of a two-sided model; transmitting, to the test equipment, the inference validation response; and receiving, from the test equipment, a validation sequence result.

The example method may further comprise: providing, to a model repository, the validation sequence result.

The example method may further comprise: transmitting, to the model repository, a request for the data set; and receiving, from the model repository, the data set.

The example method may further comprise: indicating, to the model repository, an incompatibility with a model of a machine learning enabled functionality using the two-sided model in response to the validation sequence result.

The validation sequence result may comprise a result of at least one key performance indicator used in a validation sequence with respect to the machine learning enabled functionality that may be using the two-sided model.

The at least one key performance indicator may comprise at least one of: a proxy key performance indicator, an intermediary key performance indicator, a system key performance indicator, a throughput, a latency, a bit error rate, a block error rate, a number of transmissions, a second number of receptions, a scaled generalized cosine similarity metric, or a top beam prediction accuracy.

The validation sequence result may comprise a model validation success result.

The validation sequence result may comprise a model validation failure result.

The example method may further comprise: performing at least one test procedure with respect to the at least one model in response to the validation sequence result.

The example method may further comprise: selecting a model that may be at least partially different from the at least one model in response to the validation sequence result.

The example method may further comprise: adjusting a capability of the apparatus in response to the validation sequence result.

In accordance with one example embodiment, an apparatus may comprise: circuitry configured to perform: receiving, from a test equipment, a model validation request; circuitry configured to perform: providing a data set to at least one model to obtain an inference validation response, wherein the at least one model may be used at a first side of a two-sided model; circuitry configured to perform: transmitting, to the test equipment, the inference validation response; and circuitry configured to perform: receiving, from the test equipment, a validation sequence result.

In accordance with one example embodiment, an apparatus may comprise: processing circuitry; memory circuitry including computer program code, the memory circuitry and the computer program code configured to, with the processing circuitry, enable the apparatus to: receive, from a test equipment, a model validation request; provide a data set to at least one model to obtain an inference validation response, wherein the at least one model may be used at a first side of a two-sided model; transmit, to the test equipment, the inference validation response; and receive, from the test equipment, a validation sequence result.

In accordance with one example embodiment, an apparatus may comprise means for performing: receiving, from a test equipment, a model validation request; providing a data set to at least one model to obtain an inference validation response, wherein the at least one model may be used at a first side of a two-sided model; transmitting, to the test equipment, the inference validation response; and receiving, from the test equipment, a validation sequence result.

The means may be further configured to perform: providing, to a model repository, the validation sequence result.

The means may be further configured to perform: transmitting, to the model repository, a request for the data set; and receiving, from the model repository, the data set.

The means may be further configured to perform: indicating, to the model repository, an incompatibility with a model of a machine learning enabled functionality using the two-sided model in response to the validation sequence result.

The validation sequence result may comprise a result of at least one key performance indicator used in a validation sequence with respect to the machine learning enabled functionality that may be using the two-sided model.

The at least one key performance indicator may comprise at least one of: a proxy key performance indicator, an intermediary key performance indicator, a system key performance indicator, a throughput, a latency, a bit error rate, a block error rate, a number of transmissions, a second number of receptions, a scaled generalized cosine similarity metric, or a top beam prediction accuracy.

The validation sequence result may comprise a model validation success result.

The validation sequence result may comprise a model validation failure result.

The means may be further configured to perform: at least one test procedure with respect to the at least one model in response to the validation sequence result.

The means may be further configured to perform: selecting a model that may be at least partially different from the at least one model in response to the validation sequence result.

The means may be further configured to perform: adjusting a capability of the apparatus in response to the validation sequence result.

In accordance with one example embodiment, a non-transitory computer-readable medium comprising instructions stored thereon which, when executed with at least one processor, cause the at least one processor to: cause receiving, from a test equipment, of a model validation request; cause providing of a data set to at least one model to obtain an inference validation response, wherein the at least one model may be used at a first side of a two-sided model; cause transmitting, to the test equipment, of the inference validation response; and cause receiving, from the test equipment, of a validation sequence result.

In accordance with one example embodiment, a non-transitory computer-readable medium comprising program instructions stored thereon for performing at least the following: causing receiving, from a test equipment, of a model validation request; causing providing of a data set to at least one model to obtain an inference validation response, wherein the at least one model may be used at a first side of a two-sided model; causing transmitting, to the test equipment, of the inference validation response; and causing receiving, from the test equipment, of a validation sequence result.

In accordance with another example embodiment, a non-transitory program storage device readable by a machine may be provided, tangibly embodying instructions executable by the machine for performing operations, the operations comprising: causing receiving, from a test equipment, of a model validation request; causing providing of a data set to at least one model to obtain an inference validation response, wherein the at least one model may be used at a first side of a two-sided model; causing transmitting, to the test equipment, of the inference validation response; and causing receiving, from the test equipment, of a validation sequence result.

In accordance with another example embodiment, a non-transitory computer-readable medium comprising instructions that, when executed by an apparatus, cause the apparatus to perform at least the following: causing receiving, from a test equipment, of a model validation request; causing providing of a data set to at least one model to obtain an inference validation response, wherein the at least one model may be used at a first side of a two-sided model; causing transmitting, to the test equipment, of the inference validation response; and causing receiving, from the test equipment, of a validation sequence result.

A computer implemented system comprising: at least one processor and at least one non-transitory memory storing instructions that, when executed by the at least one processor, cause the system at least to perform: causing receiving, from a test equipment, of a model validation request; causing providing of a data set to at least one model to obtain an inference validation response, wherein the at least one model may be used at a first side of a two-sided model; causing transmitting, to the test equipment, of the inference validation response; and causing receiving, from the test equipment, of a validation sequence result.

A computer implemented system comprising: means for causing receiving, from a test equipment, of a model validation request; means for causing providing of a data set to at least one model to obtain an inference validation response, wherein the at least one model may be used at a first side of a two-sided model; means for causing transmitting, to the test equipment, of the inference validation response; and means for causing receiving, from the test equipment, of a validation sequence result.

In accordance with one example embodiment, an apparatus may comprise: at least one processor; and at least one memory storing instructions that, when executed by the at least one processor, cause the apparatus at least to: enter a test mode; request, from a model repository, at least one first model for use at a first side of a two-sided model; receive, from the model repository, the at least one first model; and transmit, to a device under test, an indication of the at least one first model.

The example apparatus may be further configured to: receive, from the device under test, a second indication that the device under test may be capable of supporting at least one feature with the two-sided model; and transmit, to the device under test, a third indication of a capability to support the at least one feature with the two-sided model.

The second indication may comprise at least one of: a first identifier of a model available to the device under test, a first version of the model, a second identifier of a functionality available to the device under test, or a second version of the functionality.

The indication of the at least one first model may comprise at least one of: an update to the at least one first model, or a third identifier of the at least one first model.

In accordance with one aspect, an example method may be provided comprising: receive, from the device under test, a fourth indication that at least one second model for use at a second side of the two-sided model has been obtained, which may comprise a fourth identifier of the at least one second model.

The device under test may comprise a user equipment.

The device under test may comprise a network node.

The example method may further comprise: entering a test mode; requesting, with a test equipment from a model repository, at least one first model for use at a first side of a two-sided model; receiving, from the model repository, the at least one first model; and transmitting, to a device under test, an indication of the at least one first model.

The example method may further comprise: receiving, from the device under test, a second indication that the device under test is capable of supporting at least one feature with the two-sided model; and transmitting, to the device under test, a third indication of a capability to support the at least one feature with the two-sided model.

The second indication may comprise at least one of: a first identifier of a model available to the device under test, a first version of the model, a second identifier of a functionality available to the device under test, or a second version of the functionality.

The indication of the at least one first model may comprise at least one of: an update to the at least one first model, or a third identifier of the at least one first model.

The example method may further comprise: receiving, from the device under test, a fourth indication that at least one second model for use at a second side of the two-sided model has been obtained, which may comprise a fourth identifier of the at least one second model.

The device under test may comprise a user equipment.

The device under test may comprise a network node.

In accordance with one example embodiment, an apparatus may comprise: circuitry configured to perform: entering a test mode; requesting, from a model repository, at least one first model for use at a first side of a two-sided model; receiving, from the model repository, the at least one first model; and transmitting, to a device under test, an indication of the at least one first model.

In accordance with one example embodiment, an apparatus may comprise: processing circuitry; memory circuitry including computer program code, the memory circuitry and the computer program code configured to, with the processing circuitry, enable the apparatus to: enter a test mode; request, from a model repository, at least one first model for use at a first side of a two-sided model; receive, from the model repository, the at least one first model; and transmit, to a device under test, an indication of the at least one first model.

In accordance with one example embodiment, an apparatus may comprise means for performing: entering a test mode; requesting, from a model repository, at least one first model for use at a first side of a two-sided model; receiving, from the model repository, the at least one first model; and transmitting, to a device under test, an indication of the at least one first model.

The means may be further configured to perform: receiving, from the device under test, a second indication that the device under test is capable of supporting at least one feature with the two-sided model; and transmitting, to the device under test, a third indication of a capability to support the at least one feature with the two-sided model.

The second indication may comprise at least one of: a first identifier of a model available to the device under test, a first version of the model, a second identifier of a functionality available to the device under test, or a second version of the functionality.

The indication of the at least one first model may comprise at least one of: an update to the at least one first model, or a third identifier of the at least one first model.

The means may be further configured to perform: receiving, from the device under test, a fourth indication that at least one second model for use at a second side of the two-sided model has been obtained, which may comprise a fourth identifier of the at least one second model.

The device under test may comprise a user equipment.

The device under test may comprise a network node.

In accordance with one example embodiment, a non-transitory computer-readable medium comprising instructions stored thereon which, when executed with at least one processor, cause the at least one processor to: cause entering a test mode; cause requesting, from a model repository, of at least one first model for use at a first side of a two-sided model; cause receiving, from the model repository, of the at least one first model; and cause transmitting, to a device under test, of an indication of the at least one first model.

In accordance with one example embodiment, a non-transitory computer-readable medium comprising program instructions stored thereon for performing at least the following: causing entering a test mode; causing requesting, from a model repository, of at least one first model for use at a first side of a two-sided model; causing receiving, from the model repository, of the at least one first model; and causing transmitting, to a device under test, of an indication of the at least one first model.

In accordance with another example embodiment, a non-transitory program storage device readable by a machine may be provided, tangibly embodying instructions executable by the machine for performing operations, the operations comprising: causing entering a test mode; causing requesting, from a model repository, of at least one first model for use at a first side of a two-sided model; causing receiving, from the model repository, of the at least one first model; and causing transmitting, to a device under test, of an indication of the at least one first model.

In accordance with another example embodiment, a non-transitory computer-readable medium comprising instructions that, when executed by an apparatus, cause the apparatus to perform at least the following: causing entering a test mode; causing requesting, from a model repository, of at least one first model for use at a first side of a two-sided model; causing receiving, from the model repository, of the at least one first model; and causing transmitting, to a device under test, of an indication of the at least one first model.

A computer implemented system comprising: at least one processor and at least one non-transitory memory storing instructions that, when executed by the at least one processor, cause the system at least to perform: causing entering a test mode; causing requesting, from a model repository, of at least one first model for use at a first side of a two-sided model; causing receiving, from the model repository, of the at least one first model; and causing transmitting, to a device under test, of an indication of the at least one first model.

A computer implemented system comprising: means for causing entering a test mode; means for causing requesting, from a model repository, of at least one first model for use at a first side of a two-sided model; means for causing receiving, from the model repository, of the at least one first model; and means for causing transmitting, to a device under test, of an indication of the at least one first model.

In accordance with one example embodiment, an apparatus may comprise: at least one processor; and at least one memory storing instructions that, when executed by the at least one processor, cause the apparatus at least to: transmit, to a device under test, a model validation request; receive, from the device under test in response to the model validation request, an inference validation response; provide the inference validation response to at least one first model to obtain a corresponding inference, wherein the at least one first model may be used at the device under test, wherein the at least one first model may be part of a two-sided model; determine a validation sequence result based, at least partially, on the corresponding inference and at least one key performance indicator; and transmit, to the device under test, the validation sequence result.

The example apparatus may be further configured to: provide, to a model repository, the validation sequence result.

The at least one key performance indicator may comprise at least one of: a proxy key performance indicator, an intermediary key performance indicator, a system key performance indicator, a throughput, a latency, a bit error rate, a block error rate, a first number of transmissions, a second number of receptions, a scaled generalized cosine similarity metric, or a top beam prediction accuracy.

The validation sequence result may comprise a model validation success result.

The determining of the validation sequence result based, at least partially, on the corresponding inference and the at least one key performance indicator may comprise the example apparatus being further configured to: compare a value of the at least one key performance indicator, with respect to the corresponding inference, with a threshold; and determine that the validation sequence result may comprise the model validation success result in response to the comparison of the value with the threshold.

The validation sequence result may comprise a model validation failure result.

The determining of the validation sequence result based, at least partially, on the corresponding inference and the at least one key performance indicator may comprise the example apparatus being further configured to: compare a second value of the at least one key performance indicator, with respect to the corresponding inference, with a second threshold; and determine that the validation sequence result may comprise the model validation failure result in response to the comparison of the second value with the second threshold.

In accordance with one aspect, an example method may be provided comprising: transmitting, with a test equipment to a device under test, a model validation request; receiving, from the device under test in response to the model validation request, an inference validation response; providing the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and transmitting, to the device under test, the validation sequence result.

The example method may further comprise: providing, to a model repository, the validation sequence result.

The at least one key performance indicator may comprise at least one of: a proxy key performance indicator, an intermediary key performance indicator, a system key performance indicator, a throughput, a latency, a bit error rate, a block error rate, a first number of transmissions, a second number of receptions, a scaled generalized cosine similarity metric, or a top beam prediction accuracy.

The validation sequence result may comprise a model validation success result.

The determining of the validation sequence result based, at least partially, on the corresponding inference and the at least one key performance indicator may comprise: comparing a value of the at least one key performance indicator, with respect to the corresponding inference, with a threshold; and determining that the validation sequence result may comprise the model validation success result in response to the comparison of the value with the threshold.

The validation sequence result may comprise a model validation failure result.

The determining of the validation sequence result based, at least partially, on the corresponding inference and the at least one key performance indicator may comprise: comparing a second value of the at least one key performance indicator, with respect to the corresponding inference, with a second threshold; and determining that the validation sequence result may comprise the model validation failure result in response to the comparison of the second value with the second threshold.

In accordance with one example embodiment, an apparatus may comprise: circuitry configured to perform: transmitting, to a device under test, a model validation request; receiving, from the device under test in response to the model validation request, an inference validation response; circuitry configured to perform: providing the inference validation response to at least one first model to obtain a corresponding inference, wherein the at least one first model may be used at the device under test, wherein the at least one first model may be part of a two-sided model; circuitry configured to perform: determining a validation sequence result based, at least partially, on the corresponding inference and at least one key performance indicator; and circuitry configured to perform: transmitting, to the device under test, the validation sequence result.

In accordance with one example embodiment, an apparatus may comprise: processing circuitry; memory circuitry including computer program code, the memory circuitry and the computer program code configured to, with the processing circuitry, enable the apparatus to: transmit, to a device under test, a model validation request; receive, from the device under test in response to the model validation request, an inference validation response; provide the inference validation response to at least one first model to obtain a corresponding inference, wherein the at least one first model may be used at the device under test, wherein the at least one first model may be part of a two-sided model; determine a validation sequence result based, at least partially, on the corresponding inference and at least one key performance indicator; and transmit, to the device under test, the validation sequence result.

In accordance with one example embodiment, an apparatus may comprise means for performing: transmitting, to a device under test, a model validation request; receiving, from the device under test in response to the model validation request, an inference validation response; providing the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and transmitting, to the device under test, the validation sequence result.

The means may be further configured to perform: providing, to a model repository, the validation sequence result.

The at least one key performance indicator may comprise at least one of: a proxy key performance indicator, an intermediary key performance indicator, a system key performance indicator, a throughput, a latency, a bit error rate, a block error rate, a first number of transmissions, a second number of receptions, a scaled generalized cosine similarity metric, or a top beam prediction accuracy.

The validation sequence result may comprise a model validation success result.

The means configured to perform determining of the validation sequence result based, at least partially, on the corresponding inference and the at least one key performance indicator may comprise means configured to perform: comparing a value of the at least one key performance indicator, with respect to the corresponding inference, with a threshold; and determining that the validation sequence result may comprise the model validation success result in response to the comparison of the value with the threshold.

The validation sequence result may comprise a model validation failure result.

The means configured to perform determining of the validation sequence result based, at least partially, on the corresponding inference and the at least one key performance indicator may comprise means configured to perform: comparing a second value of the at least one key performance indicator, with respect to the corresponding inference, with a second threshold; and determining that the validation sequence result may comprise the model validation failure result in response to the comparison of the second value with the second threshold.

In accordance with one example embodiment, a non-transitory computer-readable medium comprising instructions stored thereon which, when executed with at least one processor, cause the at least one processor to: cause transmitting, to a device under test, of a model validation request; cause receiving, from the device under test in response to the model validation request, of an inference validation response; cause providing of the inference validation response to at least one first model to obtain a corresponding inference, wherein the at least one first model may be used at the device under test, wherein the at least one first model may be part of a two-sided model; determine a validation sequence result based, at least partially, on the corresponding inference and at least one key performance indicator; and cause transmitting, to the device under test, of the validation sequence result.

In accordance with one example embodiment, a non-transitory computer-readable medium comprising program instructions stored thereon for performing at least the following: causing transmitting, to a device under test, of a model validation request; causing receiving, from the device under test in response to the model validation request, of an inference validation response; causing providing of the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and causing transmitting, to the device under test, of the validation sequence result.

In accordance with another example embodiment, a non-transitory program storage device readable by a machine may be provided, tangibly embodying instructions executable by the machine for performing operations, the operations comprising: causing transmitting, to a device under test, of a model validation request; causing receiving, from the device under test in response to the model validation request, of an inference validation response; causing providing of the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and causing transmitting, to the device under test, of the validation sequence result.

In accordance with another example embodiment, a non-transitory computer-readable medium comprising instructions that, when executed by an apparatus, cause the apparatus to perform at least the following: causing transmitting, to a device under test, of a model validation request; causing receiving, from the device under test in response to the model validation request, of an inference validation response; causing providing of the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and causing transmitting, to the device under test, of the validation sequence result.

A computer implemented system comprising: at least one processor and at least one non-transitory memory storing instructions that, when executed by the at least one processor, cause the system at least to perform: causing transmitting, to a device under test, of a model validation request; causing receiving, from the device under test in response to the model validation request, of an inference validation response; causing providing of the inference validation response to at least one first model to obtain a corresponding inference, wherein the at least one first model may be used at the device under test, wherein the at least one first model may be part of a two-sided model; determining a validation sequence result based, at least partially, on the corresponding inference and at least one key performance indicator; and causing transmitting, to the device under test, of the validation sequence result.

A computer implemented system comprising: means for causing transmitting, to a device under test, of a model validation request; means for causing receiving, from the device under test in response to the model validation request, of an inference validation response; means for causing providing of the inference validation response to at least one first model to obtain a corresponding inference, wherein the at least one first model may be used at the device under test, wherein the at least one first model may be part of a two-sided model; means for determining a validation sequence result based, at least partially, on the corresponding inference and at least one key performance indicator; and means for causing transmitting, to the device under test, of the validation sequence result.

In accordance with one example embodiment, an apparatus may comprise: at least one processor; and at least one memory storing instructions that, when executed by the at least one processor, cause the apparatus at least to: receive a request for at least one model for use at a first side of a two-sided model; provide the at least one model in response to the request; and receive at least one validation sequence result with respect to the two-sided model, wherein the at least one validation sequence result may be associated with an identifier of the two-sided model.

The request may be received from a device under test.

The device under test may comprise a user equipment.

The device under test may comprise a test equipment.

The request may be received from a test equipment.

The at least one validation sequence result may comprise a model validation success result.

The at least one validation sequence result may comprise a model validation failure result.

The providing of the at least one model may comprise the example apparatus being further configured to: provide a data set for training the two-sided model.

The example apparatus may comprise one of: a device model repository, a network model repository, a centralized model repository, a local repository, or a remote repository.

In accordance with one aspect, an example method may be provided comprising: receiving, with a repository, a request for at least one model for use at a first side of a two-sided model; providing the at least one model in response to the request; and receiving at least one validation sequence result with respect to the two-sided model, wherein the at least one validation sequence result may be associated with an identifier of the two-sided model.

The request may be received from a device under test.

The device under test may comprise a user equipment.

The device under test may comprise a test equipment.

The request may be received from a test equipment.

The at least one validation sequence result may comprise a model validation success result.

The at least one validation sequence result may comprise a model validation failure result.

The providing of the at least one model may further comprise: providing a data set for training the two-sided model.

The repository may comprise one of: a device model repository, a network model repository, a centralized model repository, a local repository, or a remote repository.

In accordance with one example embodiment, an apparatus may comprise: circuitry configured to perform: receiving, a request for at least one model for use at a first side of a two-sided model; circuitry configured to perform: providing the at least one model in response to the request; and circuitry configured to perform: receiving at least one validation sequence result with respect to the two-sided model, wherein the at least one validation sequence result may be associated with an identifier of the two-sided model.

In accordance with one example embodiment, an apparatus may comprise: processing circuitry; memory circuitry including computer program code, the memory circuitry and the computer program code configured to, with the processing circuitry, enable the apparatus to: receive a request for at least one model for use at a first side of a two-sided model; provide the at least one model in response to the request; and receive at least one validation sequence result with respect to the two-sided model, wherein the at least one validation sequence result may be associated with an identifier of the two-sided model.

In accordance with one example embodiment, an apparatus may comprise means for performing: receiving a request for at least one model for use at a first side of a two-sided model; providing the at least one model in response to the request; and receiving at least one validation sequence result with respect to the two-sided model, wherein the at least one validation sequence result may be associated with an identifier of the two-sided model.

The request may be received from a device under test.

The device under test may comprise a user equipment.

The device under test may comprise a test equipment.

The request may be received from a test equipment.

The at least one validation sequence result may comprise a model validation success result.

The at least one validation sequence result may comprise a model validation failure result.

The means configured to perform providing of the at least one model may comprise means configured to perform: providing a data set for training the two-sided model.

The example apparatus may comprise one of: a device model repository, a network model repository, a centralized model repository, a local repository, or a remote repository.

In accordance with one example embodiment, a non-transitory computer-readable medium comprising instructions stored thereon which, when executed with at least one processor, cause the at least one processor to: cause receiving of a request for at least one model for use at a first side of a two-sided model; cause providing of the at least one model in response to the request; and cause receiving of at least one validation sequence result with respect to the two-sided model, wherein the at least one validation sequence result may be associated with an identifier of the two-sided model.

In accordance with one example embodiment, a non-transitory computer-readable medium comprising program instructions stored thereon for performing at least the following: causing receiving of a request for at least one model for use at a first side of a two-sided model; causing providing of the at least one model in response to the request; and causing receiving of at least one validation sequence result with respect to the two-sided model, wherein the at least one validation sequence result may be associated with an identifier of the two-sided model.

In accordance with another example embodiment, a non-transitory program storage device readable by a machine may be provided, tangibly embodying instructions executable by the machine for performing operations, the operations comprising: causing receiving of a request for at least one model for use at a first side of a two-sided model; causing providing of the at least one model in response to the request; and causing receiving of at least one validation sequence result with respect to the two-sided model, wherein the at least one validation sequence result may be associated with an identifier of the two-sided model.

In accordance with another example embodiment, a non-transitory computer-readable medium comprising instructions that, when executed by an apparatus, cause the apparatus to perform at least the following: causing receiving of a request for at least one model for use at a first side of a two-sided model; causing providing of the at least one model in response to the request; and causing receiving of at least one validation sequence result with respect to the two-sided model, wherein the at least one validation sequence result may be associated with an identifier of the two-sided model.

A computer implemented system comprising: at least one processor and at least one non-transitory memory storing instructions that, when executed by the at least one processor, cause the system at least to perform: causing receiving of a request for at least one model for use at a first side of a two-sided model; causing providing of the at least one model in response to the request; and causing receiving of at least one validation sequence result with respect to the two-sided model, wherein the at least one validation sequence result may be associated with an identifier of the two-sided model.

A computer implemented system comprising: means for causing receiving of a request for at least one model for use at a first side of a two-sided model; means for causing providing of the at least one model in response to the request; and means for causing receiving of at least one validation sequence result with respect to the two-sided model, wherein the at least one validation sequence result may be associated with an identifier of the two-sided model.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one memory storing instructions that, when executed by the at least one processor, cause the apparatus at least to perform:
entering a test mode;
receiving, from a test equipment, an indication of at least one first model used at a first side of a two-sided model;
requesting, from a model repository, at least one second model for use at a second side of the two-sided model, wherein the at least one second model is selected based, at least partially, on the at least one first model; and
receiving, from the model repository, the at least one second model.

2. The apparatus of claim 1, wherein the apparatus is further caused to perform:
transmitting, to the test equipment, a first indication of a capability to support at least one feature with the two-sided model; and
receiving, from the test equipment, a second indication that the test equipment is capable of supporting the at least one feature with the two-sided model.

3. The apparatus of claim 2, wherein the first indication comprises at least one of:
a first identifier of a model available to the apparatus,
a first version of the model,
a second identifier of a functionality available to the apparatus, or
a second version of the functionality.

4. The apparatus of claim 1, wherein the indication of the at least one first model comprises at least one of:
an update to the at least one first model, or
a third identifier of the at least one first model.

5. The apparatus of claim 1, wherein the apparatus is further caused to perform:
transmitting, to the model repository, a third indication of the test mode of the apparatus.

6. The apparatus of claim 1, wherein the model repository comprises one of:
a device model repository,
a network model repository,
a centralized model repository,
a local repository, or
a remote repository.

7. The apparatus of claim 1, wherein the apparatus is further caused to perform:
transmitting, to the test equipment, a fourth indication that the at least one second model has been obtained.

8. The apparatus of claim 1, wherein the apparatus comprises a user equipment or a network node; and wherein entering the test mode comprises entering the test mode to test the apparatus.

9. An apparatus comprising:
at least one processor; and
at least one memory storing instructions that, when executed by the at least one processor, cause the apparatus at least to perform:
receiving, from a test equipment, a model validation request;
providing a data set to at least one model to obtain an inference validation response, wherein the at least one model is used at a first side of a two-sided model;
transmitting, to the test equipment, the inference validation response; and
receiving, from the test equipment, a validation sequence result.

10. The apparatus of claim 9, wherein the apparatus is further caused to perform:
providing, to a model repository, the validation sequence result.

11. The apparatus of claim 10, wherein the apparatus is further caused to perform:
transmitting, to the model repository, a request for the data set; and
receiving, from the model repository, the data set.

12. The apparatus of claim 10, wherein the apparatus is further caused to perform:
indicating, to the model repository, an incompatibility with a model of a machine learning enabled functionality using the two-sided model in response to the validation sequence result.

13. The apparatus of claim 12, wherein the validation sequence result comprises a result of at least one key performance indicator used in a validation sequence with respect to the machine learning enabled functionality that is using the two-sided model.

14. The apparatus of claim 13, wherein the at least one key performance indicator comprises at least one of:
a proxy key performance indicator,
an intermediary key performance indicator,
a system key performance indicator,
a throughput,
a latency,
a bit error rate,
a block error rate,
a number of transmissions,
a second number of receptions,
a scaled generalized cosine similarity metric, or
a top beam prediction accuracy.

15. The apparatus of claim 9, wherein the validation sequence result comprises a model validation success result or a model validation failure result.

16. The apparatus of claim 9, wherein the apparatus is further caused to perform:
performing at least one test procedure with respect to the at least one model in response to the validation sequence result.

17. The apparatus of claim 9, wherein the apparatus is further caused to perform:
selecting a model that is at least partially different from the at least one model in response to the validation sequence result.

18. The apparatus of claim 9, wherein the apparatus is further caused to perform:
adjusting a capability of the apparatus in response to the validation sequence result.

19. An apparatus comprising:
at least one processor; and
at least one memory storing instructions that, when executed by the at least one processor, cause the apparatus at least to perform:
entering a test mode;
requesting, from a model repository, at least one first model for use at a first side of a two-sided model;
receiving, from the model repository, the at least one first model; and
transmitting, to a device under test, an indication of the at least one first model.

20. The apparatus of claim 19, wherein the apparatus is further caused to perform:
receiving, from the device under test, a second indication that the device under test is capable of supporting at least one feature with the two-sided model; and
transmitting, to the device under test, a third indication of a capability to support the at least one feature with the two-sided model.
